(19) United States
(12) Patent Application Publication
(10) Pub. No.: US 2019/0012265 A1
(43) Pub. Date: Jan. 10, 2019

(54) PROVIDING MULTI-SOCKET MEMORY COHERENCY USING CROSS-SOCKET SNOOP FILTERING IN PROCESSOR-BASED SYSTEMS

(71) Applicant: QUALCOMM Incorporated, San Diego, CA (US)

(72) Inventors: Robert James Safranek, Portland, OR (US); Joseph Gerald McDonald, Raleigh, NC (US); Robert Likovich, JR., Wake Forest, NC (US); Satish Srerambatla, Raleigh, NC (US)

(21) Appl. No.: 15/642,895

(22) Filed: Jul. 6, 2017

(51) Int. Cl. G06F 12/0817; G06F 12/0811

(52) U.S. Cl. CPC G06F 12/0828; G06F 2212/621; G06F 2212/60; G06F 12/0811

(57) ABSTRACT

Providing multi-socket memory coherency using cross-socket snoop filtering in processor-based systems is disclosed. In this regard, a processor-based system provides a plurality of processor sockets, each associated with a coherency directory including a plurality of coherency directory entries each storing status indicators corresponding to memory granules of a local memory hierarchy. A point of serialization (POS) circuit of the processor-based system receives a memory access request including a local memory address, and retrieves a coherency directory entry corresponding to the local memory address. If a status indicator of the coherency directory entry corresponding to a memory granule associated with the local memory address indicates that a remote snoop is required, the POS circuit performs the remote snoop of one or more remote processor sockets indicated by the status indicator. If not, the POS circuit returns data from the local memory hierarchy for the memory access request.

### BACKGROUND

### I. Field of the Disclosure

The technology of the disclosure relates generally to memory coherency in processor-based systems, and, in particular, to memory coherency in processor systems having multiple processor sockets.

### II. Background

Many conventional processor-based systems provide multiple processors (single- or multi-core) located on physically separate processor dies interfaced with separate processor sockets that are linked by an interconnect bus. Such multi-socket systems may provide a feature known as “multi-socket coherency” to maintain memory coherency among the multiple processor sockets' local memory hierarchy regions. To provide multi-socket coherency, each memory access request from a given processor must be evaluated (i.e., “snooped”) to determine whether a remote processor has modified the memory element corresponding to the memory address of the memory access request. A snoop to a remote processor socket (i.e., a “remote snoop”) consumes bandwidth provided by the interconnect bus, thereby reducing the bandwidth available for other inter-socket communications. Consequently, the performance of all processors of the multiple processor sockets may be negatively impacted by each memory access request that has to wait for a remote processor socket to be snooped.

To address this issue, some conventional snoop filter mechanisms employ a “shadow directory,” which is used to track the contents of a local processor socket's system caches to filter cross-socket memory access requests. However, when the storage capacity of a shadow directory of a given processor socket is reached, the snoop filter mechanism must evict an entry from the shadow directory, and must also force all remote caches to evict any corresponding entries. As a result, while the use of a shadow directory may reduce the occurrence of cross-socket snooping, such mechanisms may not be scalable for larger-sized caches and/or larger numbers of processor sockets. Thus, a more effective and scalable mechanism for filtering cross-socket snooping is desirable.

### SUMMARY OF THE DISCLOSURE

Aspects disclosed in the detailed description include providing multi-socket memory coherency using cross-socket snoop filtering in processor-based systems. In this regard, in some aspects, a processor-based system provides multiple interconnected processor sockets that are each associated with a point of serialization (POS) circuit and a local memory hierarchy subdivided into a plurality of memory granules. In some aspects, the size of the memory granules corresponds to a size of a system cache line, such as 128 bytes. Stored in the local memory hierarchy for each processor socket is a coherency directory, comprising a plurality of coherency directory entries. Each of the coherency directory entries stores one or more status indicators corresponding to the memory granules of the local memory hierarchy. The status indicators each provide an indication as to whether or not the corresponding memory granule of the local memory hierarchy has been accessed by a remote processor socket, and, in some aspects, which remote processor socket or sockets have accessed the local memory hierarchy (and thus may be caching more recent data for the memory granule). Upon receiving a memory access request referencing a local memory address of a processor socket, the POS circuit of the processor socket retrieves a coherency directory entry corresponding to the local memory address. The POS circuit then determines, based on the status indicator for the local memory address provided by the coherency directory entry, whether a remote snoop is required to determine which processor socket has the most recent data for the local memory address. If so, a remote snoop is performed. If the POS determines that a remote snoop is not required, data from the local memory hierarchy is read and returned in response to the memory access request. In this manner, the coherency directory provides an efficient and scalable mechanism for reducing the occurrence of unnecessary cross-socket snoops, thus improving system performance.

Some aspects may further provide a coherency directory cache for caching coherency directory entries for faster lookup. Aspects may also provide a remote access indicator array, which provides access indicators corresponding to portions of memory larger than a single memory granule. The remote access indicator array may be consulted prior to accessing the coherency directory, and thus may be used to determine whether a coherency directory lookup is needed.

In another aspect, a processor-based system for providing multi-socket memory coherency using cross-socket snoop filtering is provided. The processor-based system includes a plurality of processor sockets, each of which provides a coherency directory stored in a local memory hierarchy comprising a plurality of memory granules. The coherency directory includes a plurality of coherency directory entries each storing one or more status indicators corresponding to the plurality of memory granules of the local memory hierarchy. The processor-based system further includes a POS circuit. The POS circuit is configured to receive a memory access request comprising a local memory address within the local memory hierarchy. The POS circuit is further configured to retrieve a coherency directory entry of the plurality of coherency directory entries of the coherency directory corresponding to the local memory address. The POS circuit is also configured to determine, based on a status indicator of the one or more status indicators of the coherency directory entry corresponding to a memory granule of the plurality of memory granules associated with the local memory address, whether a remote snoop is required for the memory access request. The POS circuit is additionally configured to, responsive to determining that a remote snoop is required for the memory access request, perform the remote snoop of one or more remote processor sockets of the plurality of processor sockets indicated by the status indicator. The POS circuit is further configured to, responsive to determining that a remote snoop is not required for the memory access request, return data from the local memory hierarchy for the memory access request.

In another aspect, a processor-based system for providing multi-socket memory coherency using cross-socket snoop filtering is provided. The processor-based system comprises a means for receiving a memory access request comprising a local memory address within a local memory hierarchy comprising a plurality of memory granules. The processor-based system further comprises a means for retrieving a coherency directory entry of a plurality of coherency directory entries of a coherency directory corresponding to the local memory address, wherein the coherency directory is stored in the local memory hierarchy, and the plurality of coherency directory entries each stores one or more status indicators corresponding to the plurality of memory granules of the local memory hierarchy. The processor-based system also comprises a means for determining, based on a status indicator of the one or more status indicators of the coherency directory entry corresponding to a memory granule of the plurality of memory granules associated with the local memory address, whether a remote snoop is required for the memory access request. The processor-based system additionally comprises a means for performing the remote snoop of one or more remote processor sockets of a plurality of processor sockets indicated by the status indicator, responsive to determining that a remote snoop is required for the memory access request. The processor-based system further comprises a means for returning data from the local memory hierarchy for the memory access request, responsive to determining that a remote snoop is not required for the memory access request.

In another aspect, a method for providing multi-socket memory coherency using cross-socket snoop filtering is provided. The method comprises receiving, by a POS circuit, a memory access request comprising a local memory address within a local memory hierarchy comprising a plurality of memory granules. The method further comprises retrieving a coherency directory entry of a plurality of coherency directory entries of a coherency directory corresponding to the local memory address, wherein the coherency directory is stored in the local memory hierarchy, and the plurality of coherency directory entries each stores one or more status indicators corresponding to the plurality of memory granules of the local memory hierarchy. The method also comprises determining, based on a status indicator of the one or more status indicators of the coherency directory entry corresponding to a memory granule of the plurality of memory granules associated with the local memory address, whether a remote snoop is required for the memory access request. The method additionally comprises, responsive to determining that a remote snoop is required for the memory access request, performing the remote snoop of one or more remote processor sockets of a plurality of processor sockets indicated by the status indicator. The method further comprises, responsive to determining that a remote snoop is not required for the memory access request, returning data from the local memory hierarchy for the memory access request.

In another aspect, a non-transitory computer-readable medium having stored thereon computer-executable instructions is provided. The computer-executable instructions, when executed by a processor, cause the processor to receive a memory access request comprising a local memory address within a local memory hierarchy comprising a plurality of memory granules. The computer-executable instructions further cause the processor to retrieve a coherency directory entry of a plurality of coherency directory entries of a coherency directory corresponding to the local memory address, wherein the coherency directory is stored in the local memory hierarchy, and the plurality of coherency directory entries each stores one or more status indicators corresponding to the plurality of memory granules of the local memory hierarchy. The computer-executable instructions also cause the processor to determine, based on a status indicator of the one or more status indicators of the coherency directory entry corresponding to a memory granule of the plurality of memory granules associated with the local memory address, whether a remote snoop is required for the memory access request. The computer-executable instructions additionally cause the processor to, responsive to determining that a remote snoop is required for the memory access request, perform the remote snoop of one or more remote processor sockets of a plurality of processor sockets indicated by the status indicator. The computer-executable instructions further cause the processor to, responsive to determining that a remote snoop is not required for the memory access request, return data from the local memory hierarchy for the memory access request.

### BRIEF DESCRIPTION OF THE FIGURES

FIG. 1 is a block diagram of an exemplary processor-based system including multiple processor sockets each associated with a point of serialization (POS) circuit configured to provide multi-socket memory coherency using a coherency directory;

FIG. 2 is a block diagram of the coherency directory of FIG. 1, illustrating contents of coherency directory entries and contents of an exemplary status indicator;

FIG. 3 is a block diagram of a coherency directory cache and the contents thereof, for caching coherency directory entries of the coherency directory of FIGS. 1 and 2;

FIG. 4 is a block diagram of a remote access indicator array and the contents thereof for determining whether a coherency directory lookup is necessary;

FIG. 5 is a block diagram of the processor-based system of FIG. 1 and exemplary communications flows between the POS circuit of a local processor socket and the coherency directory, a coherency directory cache, a remote access indicator array, and a remote processor socket when performing cross-socket filtering;

FIGS. 6A-6E are flowcharts illustrating exemplary operations of the POS circuit of FIG. 1 for providing multi-socket memory coherency using cross-socket snoop filtering; and

FIG. 7 is block diagram of an exemplary processor-based system that can include the coherency directory and the POS circuit of FIGS. 1 and 2.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

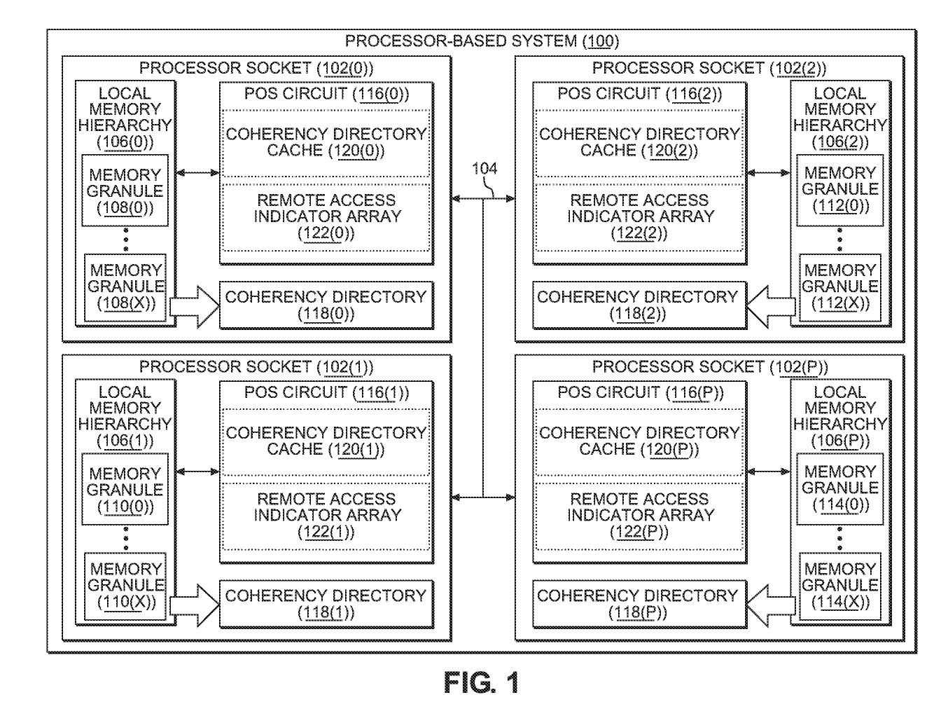

Aspects disclosed in the detailed description include providing multi-socket memory coherency using cross-socket snoop filtering in processor-based systems. In this regard, FIG. 1 illustrates an exemplary processor-based system 100 that provides multiple processor sockets 102(0)-102(P). Each of the processor sockets 102(0)-102(P) represents a connection point for a processor (not shown), such as a central processing unit (CPU), and other associated elements. The processor sockets 102(0)-102(P) are linked via an interconnect bus 104, over which inter-socket communications (such as snoop requests, as a non-limiting example) are communicated.

Each of the processor sockets 102(0)-102(P) is associated with a corresponding local memory hierarchy 106(0)-106(P). As used herein, the term “local memory hierarchy” generally refers to one or more local memory devices that are dedicated or directly connected to the corresponding processor sockets 102(0)-102(P), and are accessed in a hierarchical fashion according to response time or other performance characteristics. Accordingly, each local memory hierarchy 106(0)-106(P) in some aspects may comprise one or more of a Level 1 (L1) cache, a Level 2 (L2) cache, a Level 3 (L3) cache, and/or a system memory (e.g., double data rate (DDR) synchronous dynamic random access memory (SDRAM)), as non-limiting examples. The local memory hierarchies 106(0)-106(P) are subdivided into a plurality of memory granules 108(0)-108(X), 110(0)-110(X), 112(0)-112(X), 114(0)-114(X), respectively. In some aspects, the memory granules 108(0)-108(X), 110(0)-110(X), 112(0)-112(X), 114(0)-114(X) may have a size corresponding to a system cache line size (e.g., 128 bytes, as a non-limiting example).

The processor sockets 102(0)-102(P) are further associated with a corresponding point of serialization (POS) circuit 116(0)-116(P). Each of the POS circuits 116(0)-116(P) is configured to provide functionality for maintaining memory coherency for its local memory hierarchy 106(0)-106(P). As a non-limiting example, the functionality of the POS circuits 116(0)-116(P) may include issuing remote snoops to other processor sockets 102(0)-102(P), collecting snoop responses for given transactions, and initiating memory access operations to appropriate memory controllers (not shown). The POS circuits 116(0)-116(P) may also issue transaction results and handle transaction conflicts for a given memory address.

The processor-based system 100 of FIG. 1 may encompass any one of known digital logic elements, semiconductor circuits, processing cores, and/or memory structures, among other elements, or combinations thereof. Aspects described herein are not restricted to any particular arrangement of elements, and the disclosed techniques may be easily extended to various structures and layouts on semiconductor sockets or packages. It is to be understood that some aspects of the processor-based system 100 may include elements in addition to those illustrated in FIG. 1. As a non-limiting example, it is contemplated that the POS circuits 116(0)-116(P) may be configured to perform memory access operations by interacting with memory controllers and/or cache controllers not shown in FIG. 1.

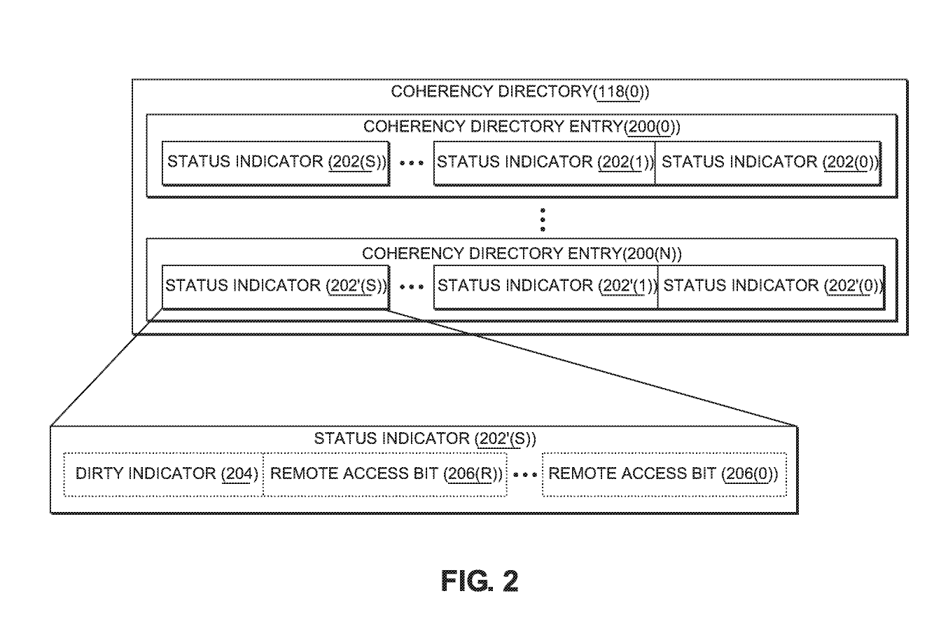

To maintain perfect memory coherency among the processor sockets 102(0)-102(P), each of the POS circuits 116(0)-116(P) would have to perform a snoop of every remote processor socket 102(0)-102(P) for every memory access request to a cacheable local memory address. However, the resulting snoop requests and snoop responses would overwhelm the interconnect bus 104, resulting in decreased system performance for all of the processor sockets 102(0)-102(P). Accordingly, in this regard, each of the processor sockets 102(0)-102(P) is associated with a corresponding coherency directory 118(0)-118(P) stored within the local memory hierarchy 106(0)-106(P). In some aspects, each coherency directory 118(0)-118(P) is stored within a system memory of the local memory hierarchy 106(0)-106(P). Performance may be further enhanced through the use of coherency directory caches 120(0)-120(P), which may be used to cache recently accessed data from the respective coherency directories 118(0)-118(P), and further through the use of remote access indicator arrays 122(0)-122(P), which may be used to minimize the latency impact of accessing the respective local memory hierarchies 106(0)-106(P). The structure and functionality of the coherency directories 118(0)-118(P), the coherency directory caches 120(0)-120(P), and the remote access indicator arrays 122(0)-122(P) are discussed in greater detail below with respect to FIGS. 2, 3, and 4, respectively.

To further illustrate the functionality provided by the coherency directories 118(0)-118(P) of FIG. 1, FIG. 2 is provided. As seen in FIG. 2, the exemplary coherency directory 118(0) provides a plurality of coherency directory entries 200(0)-200(N). Each of the coherency directory entries 200(0)-200(N) is configured to store one or more status indicators, such as status indicators 202(0)-202(S), 202′(0)-202′(S). The status indicators 202(0)-202(S), 202′(0)-202′(S) each correspond to one of the memory granules 108(0)-108(X) of FIG. 1, and indicate whether or not the corresponding memory granules 108(0)-108(X) have been accessed (and thus may be remotely cached) by a remote processor socket 102(1)-102(P). According to some aspects, the status indicators 202(0)-202(S), 202′(0)-202′(S) may further indicate the specific remote processor socket(s) 102(1)-102(P) that have accessed the corresponding memory granules 108(0)-108(X). The POS circuit 116(0) thus may use the status indicators 202(0)-202(S), 202′(0)-202′(S) to selectively snoop only the indicated remote processor socket(s) 102(1)-102(P), while avoiding snoops to remote processor sockets 102(1)-102(P) that have not accessed the corresponding memory granules 108(0)-108(X).

FIG. 2 further illustrates the contents of the exemplary status indicator 202′(S) according to some aspects. In FIG. 2, the status indicator 202′(S) provides a plurality of bits including a dirty indicator 204 and one or more remote access bits 206(0)-206(R). The dirty indicator 204 is used to indicate whether the data stored in the memory granule 108(0)-108(X) corresponding to the status indicator 202′(S) has been updated. Each of the remote access bits 206(0)-206(R) represents one of the remote processor sockets 102(1)-102(P), and, if set, indicates that the corresponding remote processor socket 102(1)-102(P) has accessed the memory granule 108(0)-108(X) associated with the status indicator 202′(S). It is to be understood that some aspects may provide more or fewer remote access bits 206(0)-206(R) than illustrated in FIG. 2. For example, according to some aspects, a single remote access bit 206(0)-206(R) may be provided to indicate that the corresponding memory granule 108(0)-108(X) has been accessed by one of the remote processor sockets 102(1)-102(P), without indicating specifically which of the remote processor sockets 102(1)-102(P) performed the memory access operation.

In exemplary operation, a POS circuit, such as the POS circuit 116(0), may receive a memory access request, and may consult the coherency directory 118(0) to determine, based on the status indicators 202(0)-202(S), 202′(0)-202′(S) of the memory granules 108(0)-108(X) being accessed, whether the memory granules 108(0)-108(X) have been previously accessed by one of the remote processor sockets 102(1)-102(P). If not, the POS circuit 116(0) may conclude that a remote snoop is not necessary, and may proceed to fulfill the memory access request using the local memory hierarchy 106(0) (e.g., by performing a memory access operation on a local cache or system memory). However, if the status indicators 202(0)-202(S), 202′(0)-202′(S) of the memory granules 108(0)-108(X) indicate that a remote access has taken place, the POS circuit 116(0) may conclude that a remote snoop of one or more of the remote processor sockets 102(1)-102(P) is necessary. In this manner, the occurrence of unnecessary remote snoops may be reduced, thus improving system performance.

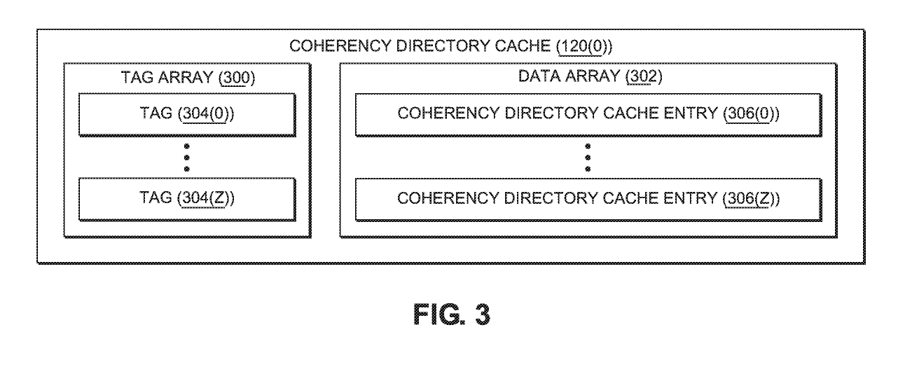

To supplement the coherency directories 118(0)-118(P) of FIGS. 1 and 2, the POS circuits 116(0)-116(P) according to some aspects may also provide the coherency directory caches 120(0)-120(P). In this regard, FIG. 3 is a block diagram of exemplary coherency directory cache 120(0) of FIG. 1 and the contents thereof. In the example of FIG. 3, the coherency directory cache 120(0) is configured to provide a tag array 300 and a data array 302, similar to conventional caches. The tag array 300 provides a plurality of tags 304(0)-304(Z), each of which corresponds to a subsection of the corresponding coherency directory 118(0) and stores a value generated according to conventional cache management mechanisms. The data array 302 of the coherency directory cache 120(0) includes a plurality of coherency directory cache entries 306(0)-306(Z). Each of the coherency directory cache entries 306(0)-306(Z) may cache the contents of one or more coherency directory entries 200(0)-200(N) of the subsection of the coherency directory 118(0) indicated by the corresponding tag 304(0)-304(Z). In aspects that provide the coherency directory cache 120(0), the POS circuit 116(0) is configured to consult the coherency directory cache 120(0) prior to accessing the coherency directory 118(0). This may provide improved access latency for data that was recently accessed from the coherency directory 118(0), further improving system performance.

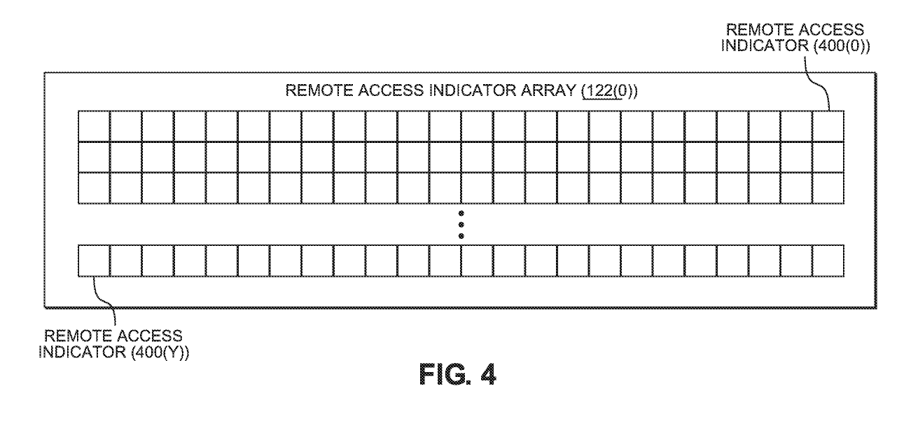

Some aspects may also further minimize the latency impact of accessing local memory addresses through the use of the remote access indicator arrays 122(0)-122(P) of FIG. 1. Referring now to FIG. 4, the exemplary remote access indicator array 122(0) of FIG. 1 and the contents thereof are illustrated. As seen in FIG. 4, the remote access indicator array 122(0) provides an array of remote access indicators 400(0)-400(Y), each of which represents a corresponding page made up of a plural subset of the plurality of memory granules 108(0)-108(X) of the local memory hierarchy 106(0). Whenever one of the remote processor sockets 102(1)-102(P) accesses a local memory address, a remote access indicator 400(0)-400(Y) corresponding to a page of memory granules 108(0)-108(X) containing the local memory address is set by the POS circuit 116(0). According to some aspects, the size of the page of memory granules 108(0)-108(X) represented by each remote access indicator 400(0)-400(Y) is configurable.

On subsequent memory access operations, the POS circuit 116(0) may access the remote access indicator array 122(0) before consulting the coherency directory 118(0) and the coherency directory cache 120(0) (if present). This allows the POS circuit 116(0) to bypass the coherency directory 118(0) and the coherency directory cache 120(0) if the remote access indicator array 122(0) indicates that a given local memory address has not been accessed by one of the remote processor sockets 102(1)-102(P). The POS circuit 116(0) may later clear the remote access indicators 400(0)-400(Y) whenever an access of the coherency directory 118(0) indicates that no memory granules 108(0)-108(X) within the corresponding pages are cached remotely.

In some aspects, the POS circuit 116(0) may update the contents of the remote access indicator array 122(0) to ensure that the remote access indicators 400(0)-400(Y) provide an accurate representation of the status of the corresponding page of memory granules 108(0)-108(X). In such aspects, the POS circuit 116(0) may process the coherency directory entries 200(0)-200(N) of the coherency directory 118(0) to determine whether the status indicators 202(0)-202(S), 202′(0)-202′(S) are set. If none of the status indicators 202(0)-202(S), 202′(0)-202′(S) for a page of memory granules 108(0)-108(X) that corresponds to a given remote access indicator 400(0)-400(Y) are set, the POS circuit 116(0) clears that remote access indicator 400(0)-400(Y) in the remote access indicator array 122(0). In this manner, the accuracy of contents of the remote access indicator array 122(0) may be maintained over time as the memory granules 108(0)-108(X) are accessed by remote processor sockets.

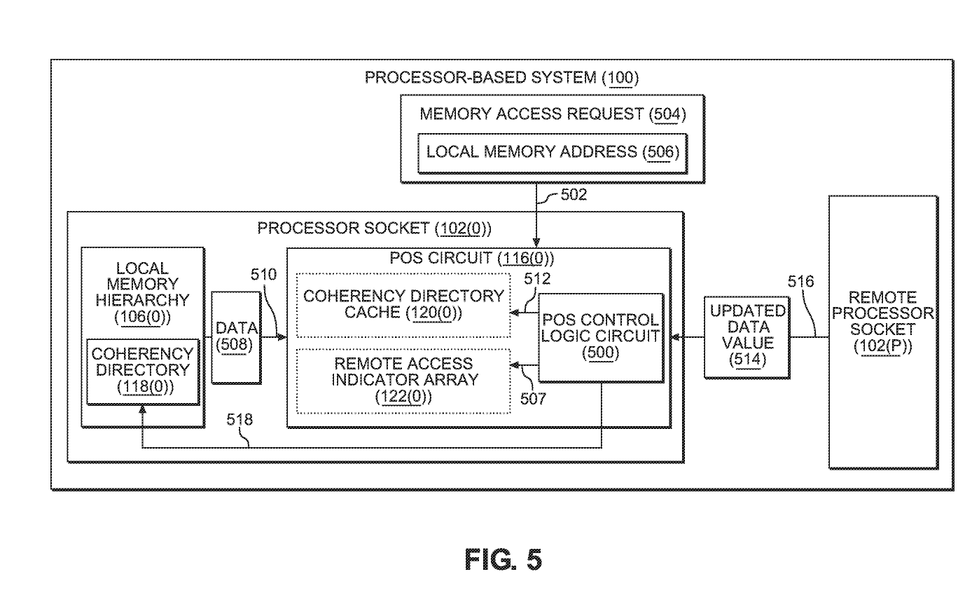

FIG. 5 is provided to illustrate exemplary communications flows between a POS circuit, such as the POS circuit 116(0) of the processor socket 102(0) of FIG. 1, and the coherency directory 118(0), the coherency directory cache 120(0), the remote access indicator array 122(0), and a remote processor socket, such as the remote processor socket 102(P), when performing cross-socket filtering. FIG. 5 shows the processor-based system 100 of FIG. 1, including the processor socket 102(0) and the remote processor socket 102(P). In this example, the POS circuit 116(0) of the processor socket 102(0) provides a POS control logic circuit 500 that is responsible for controlling the functionality of the POS circuit 116(0).

As indicated by arrow 502, the POS circuit 116(0) of the processor socket 102(0) receives a memory access request 504 (e.g., a memory read request or a memory write request) including a local memory address 506 (i.e., “local” with respect to the local memory hierarchy 106(0) of the processor socket 102(0)). In aspects providing a remote access indicator array 122(0), the POS control logic circuit 500 first accesses the remote access indicator array 122(0) to determine whether a remote access indicator, (such as the remote access indicators 400(0)-400(Y) of FIG. 4) corresponding to a page containing the local memory address 506 is set, as indicated by arrow 507. If not, the POS circuit 116(0) may conclude that the data stored in the local memory hierarchy 106(0) is valid, and the POS circuit 116(0) may return data 508 from the local memory hierarchy 106(0) in response to the memory access request 504, as indicated by arrow 510.

However, if the remote access indicator 400(0)-400(Y) corresponding to the page containing the local memory address 506 is set, the POS control logic circuit 500 may next consult the coherency directory cache 120(0), as indicated by arrow 512. The POS control logic circuit 500 of the POS circuit 116(0) determines whether a coherency directory cache entry, such as the coherency directory cache entries 306(0)-306(Z) of FIG. 3, corresponds to the local memory address 506 of the memory access request 504. If accessing the coherency directory cache 120(0) results in a hit (i.e., the coherency directory cache 120(0) contains cached data that was recently retrieved from the coherency directory 118(0) and that corresponds to the local memory address 506), the POS control logic circuit 500 will use the cached data to determine whether a remote snoop of the remote processor socket 102(P) is required, or if the memory access request 504 can be fulfilled by accessing the local memory hierarchy 106(0). In the former case, the POS circuit 116(0) may perform a snoop of the remote processor socket 102(P), and if the remote processor socket 102(P) is caching an updated data value 514 for the local memory address 506, the POS circuit 116(0) may return the updated data value 514 in response to the memory access request 504, as indicated by arrow 516. Otherwise, the POS circuit 116(0) may return data 508 from the local memory hierarchy 106(0) in response to the memory access request 504, as indicated by arrow 510.

If accessing the coherency directory cache 120(0) results in a miss, the POS control logic circuit 500 consults the coherency directory 118(0) to retrieve a coherency directory entry, such as the coherency directory entries 200(0)-200(N), corresponding to the local memory address 506 of the memory access request 504, as indicated by arrow 518. Based on the coherency directory 118(0), the POS control logic circuit 500 determines whether a remote snoop of the remote processor socket 102(P) is required, or if the memory access request 504 can be fulfilled by accessing the local memory hierarchy 106(0). If a remote snoop is required, the POS circuit 116(0) may perform a snoop of the remote processor socket 102(P), and if the remote processor socket 102(P) is caching the updated data value 514 for the local memory address 506, the POS circuit 116(0) returns the updated data value 514 in response to the memory access request 504, as indicated by arrow 516. If no remote snoop is required, the POS circuit 116(0) returns data 508 from the local memory hierarchy 106(0) in response to the memory access request 504, as indicated by arrow 510.

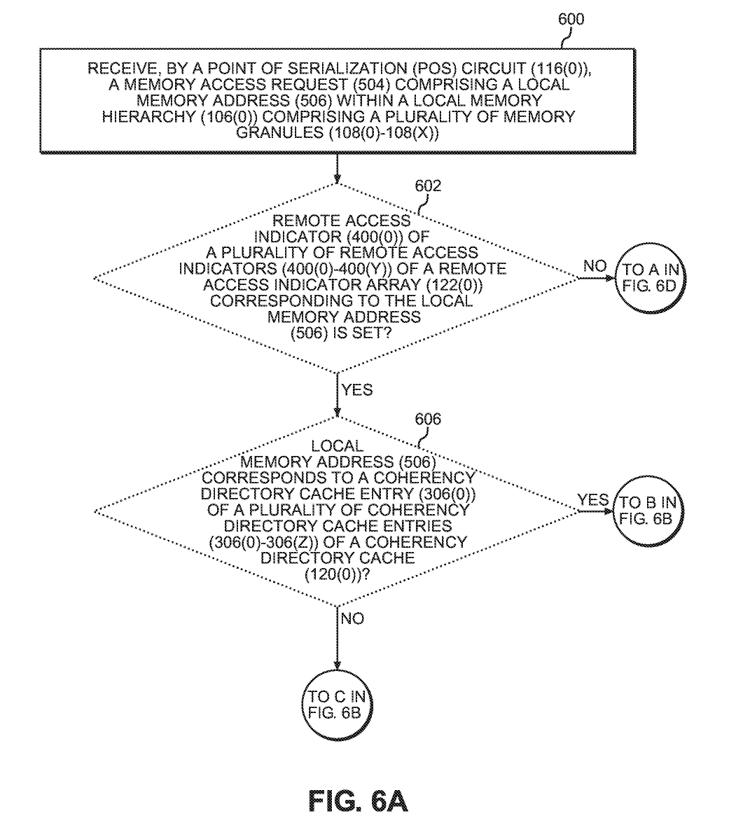

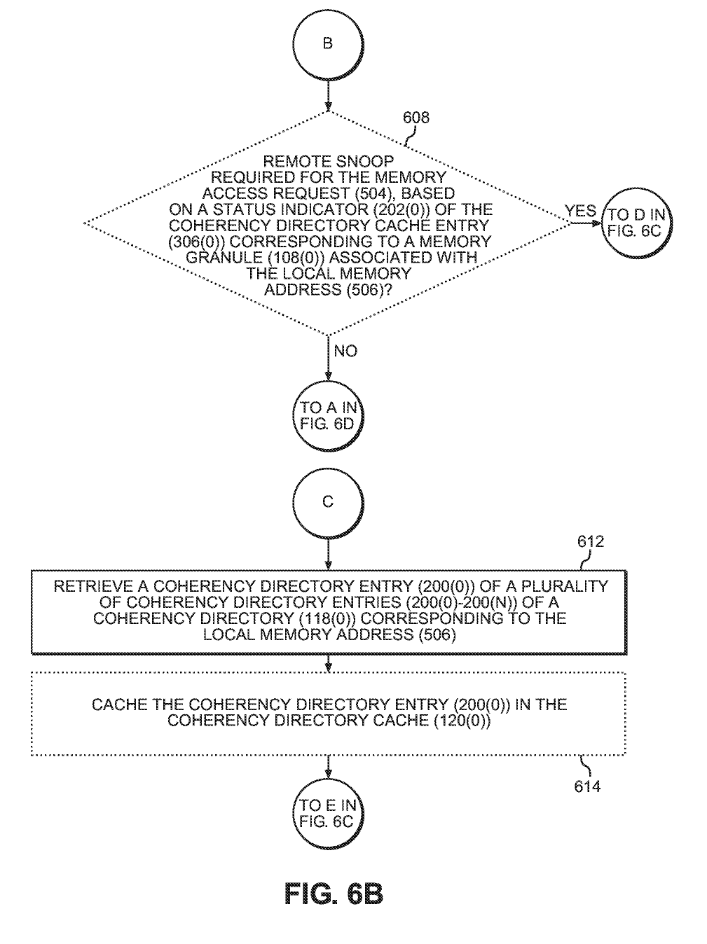

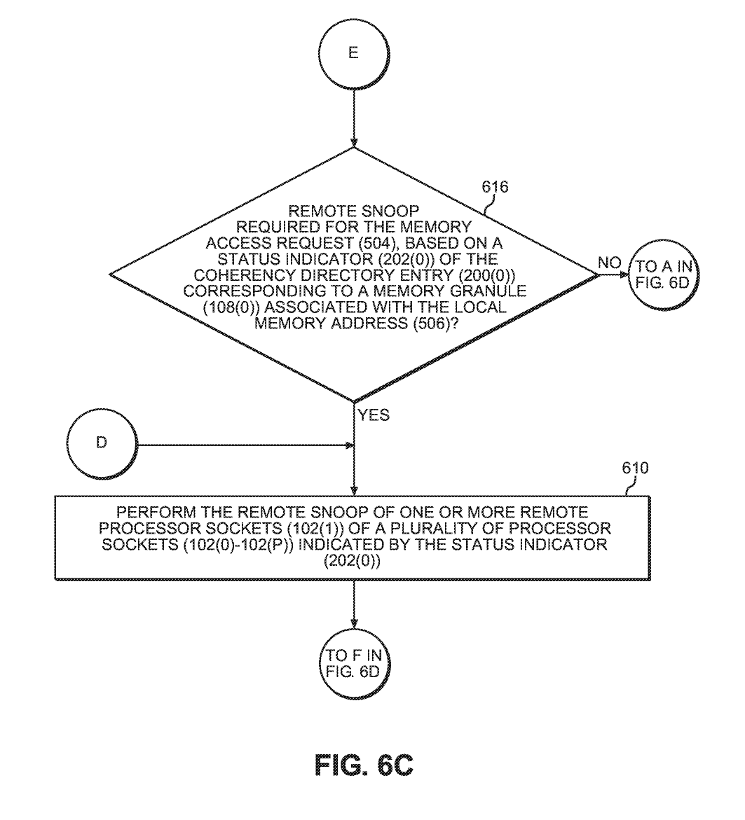

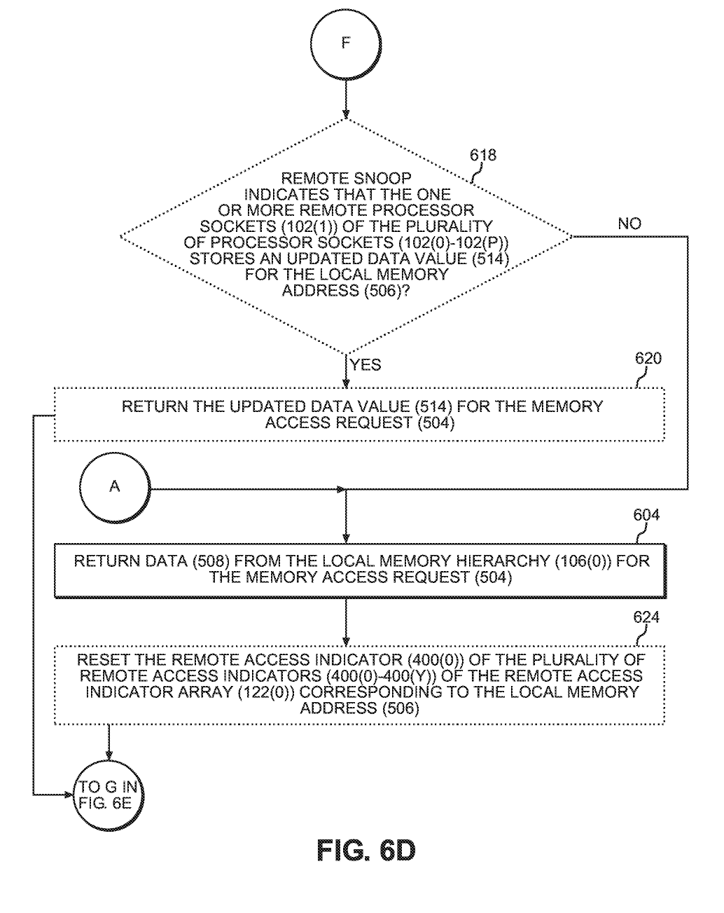

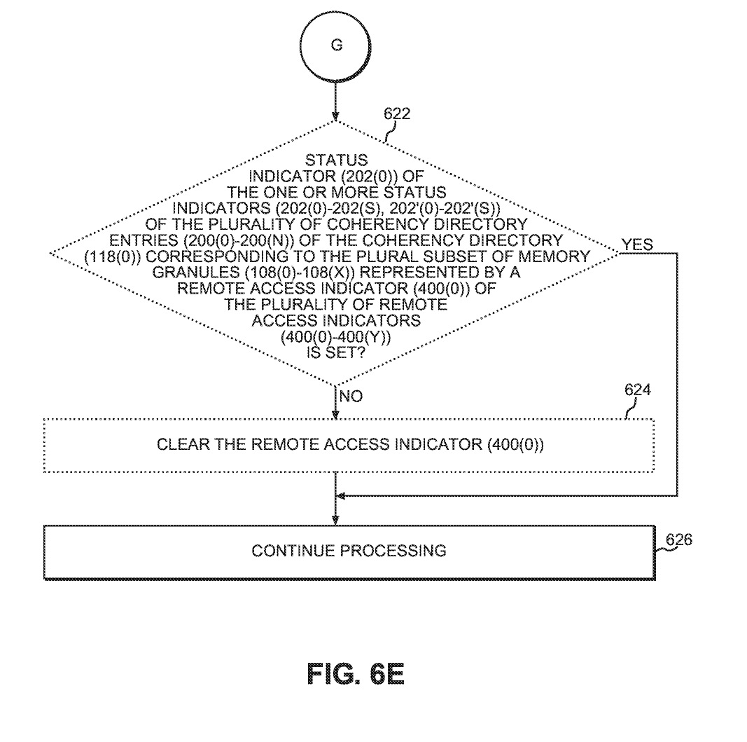

To illustrate exemplary operations of the POS circuit 116(0) of FIG. 1 for providing multi-socket memory coherency using cross-socket snoop filtering, FIGS. 6A-6E are provided. For the sake of clarity, elements of FIGS. 1-5 are referenced in describing FIGS. 6A-6E. In FIG. 6A, processing begins with the POS circuit 116(0) receiving a memory access request 504 comprising a local memory address 506 within a local memory hierarchy 106(0) comprising a plurality of memory granules 108(0)-108(X) (block 600). Accordingly, the POS circuit 116(0) may be referred to herein as “a means for receiving a memory access request comprising a local memory address within a local memory hierarchy comprising a plurality of memory granules.”

In aspects in which the POS circuit 116(0) provides the remote access indicator array 122(0), the POS circuit 116(0) may next determine whether a remote access indicator 400(0) of a plurality of remote access indicators 400(0)-400(Y) of a remote access indicator array 122(0) corresponding to the local memory address 506 is set (block 602). If not (indicating that the corresponding page containing the local memory address 506 has not been remotely accessed), processing resumes at block 604 of FIG. 6D. However, if the POS circuit 116(0) determines at decision block 602 that the remote access indicator 400(0) is set, the POS circuit 116(0), in aspects providing the coherency directory cache 120(0), may next determine whether the local memory address 506 corresponds to a coherency directory cache entry 306(0) of a plurality of coherency directory cache entries 306(0)-306(Z) of a coherency directory cache 120(0) (block 606). If so (i.e., a cache hit occurs on the coherency directory cache 120(0)), processing resumes at block 608 of FIG. 6B. If a miss on the coherency directory cache 120(0) occurs, processing resumes at block 610 of FIG. 6B.

Referring now to FIG. 6B, if a cache hit occurs on the coherency directory cache 120(0) at block 606 of FIG. 6A, the POS circuit 116(0) next determines, based on a status indicator 202(0) of the coherency directory cache entry 306(0) corresponding to a memory granule 108(0) associated with the local memory address 506, whether a remote snoop is required for the memory access request 504 (block 608). If a remote snoop is required, processing resumes at block 610 of FIG. 6C. However if the POS circuit 116(0) determines at decision block 608 that no remote snoop is required, processing continues at block 604 of FIG. 6D.

With continuing reference to FIG. 6B, if a cache miss occurs on the coherency directory cache 120(0) at block 606 of FIG. 6A, the POS circuit 116(0) retrieves a coherency directory entry 200(0) of a plurality of coherency directory entries 200(0)-200(N) of a coherency directory 118(0) corresponding to the local memory address 506 (block 612). The POS circuit 116(0) thus may be referred to herein as “a means for retrieving a coherency directory entry of a plurality of coherency directory entries of a coherency directory corresponding to the local memory address.” In aspects in which the coherency directory cache 120(0) is provided, the POS circuit 116(0) may also cache the coherency directory entry 200(0) in the coherency directory cache 120(0) (block 614). Processing then resumes at block 616 in FIG. 6C.

Turning to FIG. 6C, the POS circuit 116(0) then determines, based on a status indicator 202(0) of the coherency directory entry 200(0) corresponding to a memory granule 108(0) associated with the local memory address 506, whether a remote snoop is required for the memory access request 504 (block 616). In this regard, the POS circuit 116(0) may be referred to herein as “a means for determining, based on a status indicator of the one or more status indicators of the coherency directory entry corresponding to a memory granule of the plurality of memory granules associated with the local memory address, whether a remote snoop is required for the memory access request.” If a remote snoop is not required, processing resumes at block 604 of FIG. 6D. However, if the POS circuit 116(0) determines at decision block 616 that a remote snoop is required, the POS circuit 116(0) performs the remote snoop of one or more remote processor sockets 102(1) of a plurality of processor sockets 102(0)-102(P) indicated by the status indicator 202(0) (block 610). Accordingly, the POS circuit 116(0) may be referred to herein as “a means for performing the remote snoop of one or more remote processor sockets of a plurality of processor sockets indicated by the status indicator, responsive to determining that a remote snoop is required for the memory access request.” Processing then resumes at block 618 of FIG. 6D.

Referring now to FIG. 6D, the POS circuit 116(0) in some aspects determines whether the remote snoop indicates that the one or more remote processor sockets 102(1) of the plurality of processor sockets 102(0)-102(P) stores an updated data value 514 for the local memory address 506 (block 618). If so, the POS circuit 116(0) returns the updated data value 514 for the memory access request 504 (block 620). Processing then resumes at block 622 of FIG. 6E. If the POS circuit 116(0) determines at decision block 618 that the remote snoop indicates that the one or more remote processor sockets 102(1) do not store an updated data value 514 for the local memory address 506, the POS circuit 116(0) returns data 508 from the local memory hierarchy 106(0) for the memory access request 504 (block 604). The POS circuit 116(0) thus may be referred to herein as “a means for returning data from the local memory hierarchy for the memory access request, responsive to determining that a remote snoop is not required for the memory access request.” Note that the POS circuit 116(0) also performs the operations of block 604 if the POS circuit 116(0) determines at decision block 602 of FIG. 6A that the remote access indicator 400(0) corresponding to the local memory address 506 is not set, or if the POS circuit 116(0) determines at decision block 608 of FIG. 6B or decision block 616 of FIG. 6C that a remote snoop is not required. Finally, in aspects of the POS circuit 116(0) providing a remote access indicator array 122(0), the POS circuit 116(0), after returning the data 508 from the local memory hierarchy 106(0), may reset the remote access indicator 400(0) of the plurality of remote access indicators 400(0)-400(Y) of the remote access indicator array 122(0) corresponding to the local memory address 506 (block 624). Processing then resumes at block 622 of FIG. 6E.

In FIG. 6E, the POS circuit 116(0) in some aspects may determine whether a status indicator 202(0) of the one or more status indicators 202(0)-202(S), 202′(0)-202′(S) of the plurality of coherency directory entries 200(0)-200(N) of the coherency directory 118(0) corresponding to the plural subset of memory granules 108(0)-108(X) represented by a remote access indicator 400(0) of the plurality of remote access indicators 400(0)-400(Y) is set (block 622). If no status indicator 202(0)-202(S), 202′(0)-202′(S) corresponding to the memory granules 108(0)-108(X) represented by the remote access indicator 400(0) are set, the POS circuit 116(0) may clear the remote access indicator 400(0) (block 626). Processing then continues (block 628). If the POS circuit 116(0) determines at decision block 622 that one or more status indicators 202(0)-202(S), 202′(0)-202′(S) corresponding to the memory granules 108(0)-108(X) represented by the remote access indicator 400(0) are set, processing continues with no change to the remote access indicator 400(0) (block 628).

Providing multi-socket memory coherency using cross-socket snoop filtering in processor-based systems according to aspects disclosed herein may be provided in or integrated into any processor-based device. Examples, without limitation, include a set top box, an entertainment unit, a navigation device, a communications device, a fixed location data unit, a mobile location data unit, a global positioning system (GPS) device, a mobile phone, a cellular phone, a smart phone, a session initiation protocol (SIP) phone, a tablet, a phablet, a server, a computer, a portable computer, a mobile computing device, a wearable computing device (e.g., a smart watch, a health or fitness tracker, eyewear, etc.), a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, a vehicle component, avionics systems, a drone, and a multicopter.

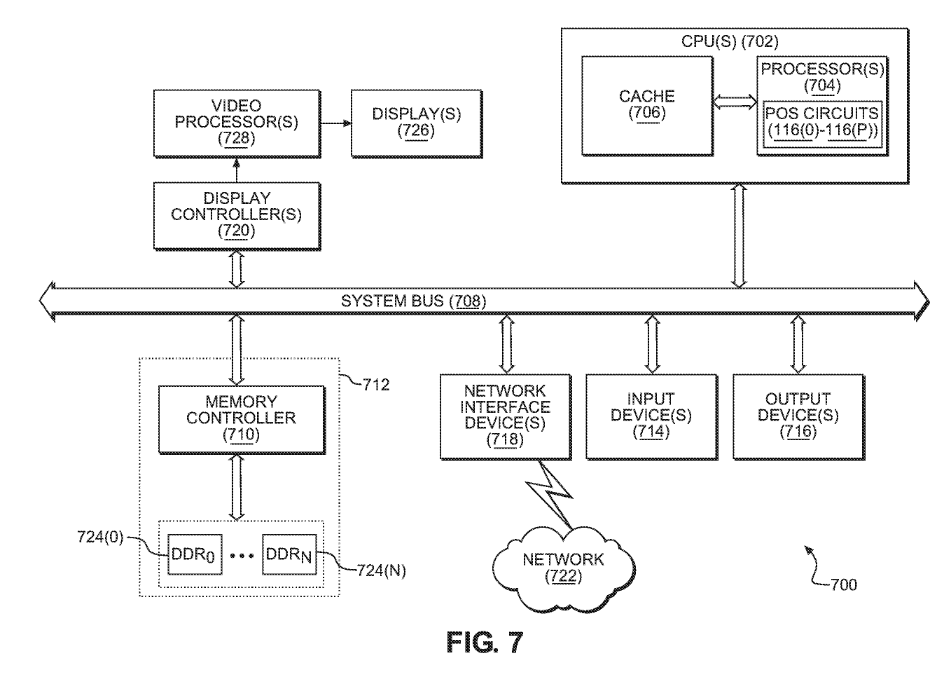

In this regard, FIG. 7 illustrates an example of a processor-based system 700 that can employ the POS circuits 116(0)-116(P) and the coherency directories 118(0)-118(P) illustrated in FIGS. 1 and 2. The processor-based system 700 includes one or more CPUs 702, each including one or more processors 704. The CPU(s) 702 may have cache memory 706 coupled to the processor(s) 704 for rapid access to temporarily stored data, and in some aspects may correspond to the processor sockets 102(0)-102(P) of FIG. 1 and may comprise the POS circuits 116(0)-116(P) of FIG. 1. The CPU(s) 702 is coupled to a system bus 708 and can intercouple master and slave devices included in the processor-based system 700. As is well known, the CPU(s) 702 communicates with these other devices by exchanging address, control, and data information over the system bus 708. For example, the CPU(s) 702 can communicate bus transaction requests to a memory controller 710 as an example of a slave device.

Other master and slave devices can be connected to the system bus 708. As illustrated in FIG. 7, these devices can include a memory system 712, one or more input devices 714, one or more output devices 716, one or more network interface devices 718, and one or more display controllers 720, as examples. The input device(s) 714 can include any type of input device, including but not limited to input keys, switches, voice processors, etc. The output device(s) 716 can include any type of output device, including, but not limited to, audio, video, other visual indicators, etc. The network interface device(s) 718 can be any devices configured to allow exchange of data to and from a network 722. The network 722 can be any type of network, including, but not limited to, a wired or wireless network, a private or public network, a local area network (LAN), a wireless local area network (WLAN), a wide area network (WAN), a BLUETOOTH™ network, and the Internet. The network interface device(s) 718 can be configured to support any type of communications protocol desired. The memory system 712 can include one or more memory units 724(0)-724(N), and may store the coherency directories 118(0)-118(P) of FIGS. 1 and 2.

The CPU(s) 702 may also be configured to access the display controller(s) 720 over the system bus 708 to control information sent to one or more displays 726. The display controller(s) 720 sends information to the display(s) 726 to be displayed via one or more video processors 728, which process the information to be displayed into a format suitable for the display(s) 726. The display(s) 726 can include any type of display, including, but not limited to, a cathode ray tube (CRT), a liquid crystal display (LCD), a plasma display, etc.

Those of skill in the art will further appreciate that the various illustrative logical blocks, modules, circuits, and algorithms described in connection with the aspects disclosed herein may be implemented as electronic hardware, instructions stored in memory or in another computer readable medium and executed by a processor or other processing device, or combinations of both. The master devices, and slave devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be provided in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A processor-based system for providing multi-socket memory coherency using cross-socket snoop filtering, comprising:
a plurality of processor sockets, each associated with:
a coherency directory stored in a local memory hierarchy comprising a plurality of memory granules, the coherency directory comprising a plurality of coherency directory entries each storing one or more status indicators corresponding to the plurality of memory granules of the local memory hierarchy; and
a point of serialization (POS) circuit configured to:
receive a memory access request comprising a local memory address within the local memory hierarchy;
retrieve a coherency directory entry of the plurality of coherency directory entries of the coherency directory corresponding to the local memory address;
determine, based on a status indicator of the one or more status indicators of the coherency directory entry corresponding to a memory granule of the plurality of memory granules associated with the local memory address, whether a remote snoop is required for the memory access request;
responsive to determining that a remote snoop is required for the memory access request, perform the remote snoop of one or more remote processor sockets of the plurality of processor sockets indicated by the status indicator; and
responsive to determining that a remote snoop is not required for the memory access request, return data from the local memory hierarchy for the memory access request.

2. The processor-based system of claim 1, wherein:
each status indicator of the one or more status indicators comprises a plurality of bits;
one (1) bit of the plurality of bits comprises a dirty indicator; and
one or more remaining bits of the plurality of bits each comprises a remote access bit indicating whether a corresponding remote processor socket of the plurality of processor sockets has accessed the memory granule of the local memory hierarchy associated with the status indicator.

3. The processor-based system of claim 1, wherein the POS circuit is further configured to:
determine whether the remote snoop indicates that the one or more remote processor sockets of the plurality of processor sockets stores an updated data value for the local memory address;
responsive to determining that the remote snoop indicates that the one or more remote processor sockets of the plurality of processor sockets stores an updated data value for the local memory address, return the updated data value for the memory access request; and
responsive to determining that the remote snoop indicates that no remote processor sockets of the plurality of processor sockets stores an updated data value for the local memory address, return data from the local memory hierarchy for the memory access request.

4. The processor-based system of claim 1, wherein:
the plurality of processor sockets are each further associated with a coherency directory cache comprising a plurality of coherency directory cache entries;
the POS circuit is further configured to, prior to retrieving the coherency directory entry of the plurality of coherency directory entries of the coherency directory corresponding to the local memory address:
determine whether the local memory address corresponds to a coherency directory cache entry of the plurality of coherency directory cache entries of the coherency directory cache; and
responsive to determining that the local memory address corresponds to a coherency directory cache entry, determine, based on a status indicator of the coherency directory cache entry corresponding to a memory granule associated with the local memory address, whether a remote snoop is required for the memory access request; and
the POS circuit is configured to retrieve the coherency directory entry of the plurality of coherency directory entries of the coherency directory corresponding to the local memory address responsive to determining that the local memory address does not correspond to a coherency directory cache entry of the plurality of coherency directory cache entries of the coherency directory cache.

5. The processor-based system of claim 4, wherein the POS circuit is further configured to, subsequent to retrieving the coherency directory entry of the plurality of coherency directory entries of the coherency directory corresponding to the local memory address, cache the coherency directory entry in the coherency directory cache.

6. The processor-based system of claim 1, wherein:
the plurality of processor sockets are each further associated with a remote access indicator array comprising a plurality of remote access indicators each representing a plural subset of the plurality of memory granules of the local memory hierarchy;
the POS circuit is further configured to, prior to retrieving the coherency directory entry of the plurality of coherency directory entries of the coherency directory corresponding to the local memory address, determine whether a remote access indicator of the plurality of remote access indicators of the remote access indicator array corresponding to the local memory address is set; and
the POS circuit is configured to:
retrieve the coherency directory entry of the plurality of coherency directory entries of the coherency directory corresponding to the local memory address responsive to determining that a remote access indicator of the plurality of remote access indicators of the remote access indicator array corresponding to the local memory address is set; and
return data from the local memory hierarchy for the memory access request responsive to determining that a remote access indicator of the plurality of remote access indicators of the remote access indicator array corresponding to the local memory address is not set.

7. The processor-based system of claim 6, wherein the POS circuit is further configured to, subsequent to performing the remote snoop of the one or more remote processor sockets of the plurality of processor sockets indicated by the status indicator, reset the remote access indicator of the plurality of remote access indicators of the remote access indicator array corresponding to the local memory address.

8. The processor-based system of claim 6, wherein the POS circuit is further configured to:
determine whether any status indicator of the one or more status indicators of the plurality of coherency directory entries of the coherency directory corresponding to the plural subset of memory granules represented by a remote access indicator of the plurality of remote access indicators is set; and
responsive to determining that no status indicator of the one or more status indicators corresponding to the plural subset of memory granules is set, clear the remote access indicator.

9. The processor-based system of claim 1 integrated into an integrated circuit (IC).

10. The processor-based system of claim 1 integrated into a device selected from the group consisting of: a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device (e.g., a smart watch, a health or fitness tracker, eyewear, etc.); a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; avionics systems; a drone; and a multicopter.

11. A processor-based system for providing multi-socket memory coherency using cross-socket snoop filtering, comprising:
a means for receiving a memory access request comprising a local memory address within a local memory hierarchy comprising a plurality of memory granules;
a means for retrieving a coherency directory entry of a plurality of coherency directory entries of a coherency directory corresponding to the local memory address, wherein:
the coherency directory is stored in the local memory hierarchy; and
the plurality of coherency directory entries each stores one or more status indicators corresponding to the plurality of memory granules of the local memory hierarchy;
a means for determining, based on a status indicator of the one or more status indicators of the coherency directory entry corresponding to a memory granule of the plurality of memory granules associated with the local memory address, whether a remote snoop is required for the memory access request;
a means for performing the remote snoop of one or more remote processor sockets of a plurality of processor sockets indicated by the status indicator, responsive to determining that a remote snoop is required for the memory access request; and
a means for returning data from the local memory hierarchy for the memory access request, responsive to determining that a remote snoop is not required for the memory access request.

12. A method for providing multi-socket memory coherency using cross-socket snoop filtering, comprising:
receiving, by a point of serialization (POS) circuit, a memory access request comprising a local memory address within a local memory hierarchy comprising a plurality of memory granules;
retrieving a coherency directory entry of a plurality of coherency directory entries of a coherency directory corresponding to the local memory address, wherein:
the coherency directory is stored in the local memory hierarchy; and
the plurality of coherency directory entries each stores one or more status indicators corresponding to the plurality of memory granules of the local memory hierarchy;
determining, based on a status indicator of the one or more status indicators of the coherency directory entry corresponding to a memory granule of the plurality of memory granules associated with the local memory address, whether a remote snoop is required for the memory access request;
responsive to determining that a remote snoop is required for the memory access request, performing the remote snoop of one or more remote processor sockets of a plurality of processor sockets indicated by the status indicator; and
responsive to determining that a remote snoop is not required for the memory access request, returning data from the local memory hierarchy for the memory access request.

13. The method of claim 12, wherein:
each status indicator of the one or more status indicators comprises a plurality of bits;
one (1) bit of the plurality of bits comprises a dirty indicator; and
one or more remaining bits of the plurality of bits each comprises a remote access bit indicating whether a corresponding remote processor socket of the plurality of processor sockets has accessed the memory granule of the local memory hierarchy associated with the status indicator.

14. The method of claim 12, further comprising:
determining whether the remote snoop indicates that the one or more remote processor sockets of the plurality of processor sockets stores an updated data value for the local memory address;
responsive to determining that the remote snoop indicates that the one or more remote processor sockets of the plurality of processor sockets stores an updated data value for the local memory address, returning the updated data value for the memory access request; and
responsive to determining that the remote snoop indicates that no remote processor sockets of the plurality of processor sockets stores an updated data value for the local memory address, returning data from the local memory hierarchy for the memory access request.

15. The method of claim 12, further comprising, prior to retrieving the coherency directory entry of the plurality of coherency directory entries of the coherency directory corresponding to the local memory address:
determining whether the local memory address corresponds to a coherency directory cache entry of a plurality of coherency directory cache entries of a coherency directory cache; and
responsive to determining that the local memory address corresponds to a coherency directory cache entry, determining, based on a status indicator of the coherency directory cache entry corresponding to a memory granule associated with the local memory address, whether a remote snoop is required for the memory access request;
wherein retrieving the coherency directory entry of the plurality of coherency directory entries of the coherency directory corresponding to the local memory address is responsive to determining that the local memory address does not correspond to a coherency directory cache entry of the plurality of coherency directory cache entries of the coherency directory cache.

16. The method of claim 15, further comprising, subsequent to retrieving the coherency directory entry of the plurality of coherency directory entries of the coherency directory corresponding to the local memory address, caching the coherency directory entry in the coherency directory cache.

17. The method of claim 12, further comprising, prior to retrieving the coherency directory entry of the plurality of coherency directory entries of the coherency directory corresponding to the local memory address, determining whether a remote access indicator of a plurality of remote access indicators of a remote access indicator array corresponding to the local memory address is set;
wherein:
retrieving the coherency directory entry of the plurality of coherency directory entries of the coherency directory corresponding to the local memory address is responsive to determining that a remote access indicator of the plurality of remote access indicators of the remote access indicator array corresponding to the local memory address is set; and
returning data from the local memory hierarchy for the memory access request is responsive to determining that a remote access indicator of the plurality of remote access indicators of the remote access indicator array corresponding to the local memory address is not set.

18. The method of claim 17, further comprising, subsequent to performing the remote snoop of the one or more remote processor sockets of the plurality of processor sockets indicated by the status indicator, resetting the remote access indicator of the plurality of remote access indicators of the remote access indicator array corresponding to the local memory address.

19. The method of claim 17, further comprising:
determining whether any status indicator of the one or more status indicators of the plurality of coherency directory entries of the coherency directory corresponding to the plural subset of memory granules represented by a remote access indicator of the plurality of remote access indicators is set; and
responsive to determining that no status indicator of the one or more status indicators corresponding to the plural subset of memory granules is set, clearing the remote access indicator.

20. A non-transitory computer-readable medium having stored thereon computer-executable instructions which, when executed by a processor, cause the processor to:
receive a memory access request comprising a local memory address within a local memory hierarchy comprising a plurality of memory granules;
retrieve a coherency directory entry of a plurality of coherency directory entries of a coherency directory corresponding to the local memory address,
wherein:
the coherency directory is stored in the local memory hierarchy; and
the plurality of coherency directory entries each stores one or more status indicators corresponding to the plurality of memory granules of the local memory hierarchy;
determine, based on a status indicator of the one or more status indicators of the coherency directory entry corresponding to a memory granule of the plurality of memory granules associated with the local memory address, whether a remote snoop is required for the memory access request;
responsive to determining that a remote snoop is required for the memory access request, perform the remote snoop of one or more remote processor sockets of a plurality of processor sockets indicated by the status indicator; and
responsive to determining that a remote snoop is not required for the memory access request, return data from the local memory hierarchy for the memory access request.

21. The non-transitory computer-readable medium of claim 20 having stored thereon computer-executable instructions which, when executed by a processor, further cause the processor to configure the plurality of coherency directory entries of the coherency directory such that:
each status indicator of the one or more status indicators comprises a plurality of bits;
one (1) bit of the plurality of bits comprises a dirty indicator; and
one or more remaining bits of the plurality of bits each comprises a remote access bit indicating whether a corresponding remote processor socket of the plurality of processor sockets has accessed the memory granule of the local memory hierarchy associated with the status indicator.

22. The non-transitory computer-readable medium of claim 20 having stored thereon computer-executable instructions which, when executed by a processor, further cause the processor to:
determine whether the remote snoop indicates that the one or more remote processor sockets of the plurality of processor sockets stores an updated data value for the local memory address;
responsive to determining that the remote snoop indicates that the one or more remote processor sockets of the plurality of processor sockets stores an updated data value for the local memory address, return the updated data value for the memory access request; and
responsive to determining that the remote snoop indicates that no remote processor sockets of the plurality of processor sockets stores an updated data value for the local memory address, return data from the local memory hierarchy for the memory access request.

23. The non-transitory computer-readable medium of claim 20 having stored thereon computer-executable instructions which, when executed by a processor, further cause the processor to, prior to retrieving the coherency directory entry of the plurality of coherency directory entries of the coherency directory corresponding to the local memory address:
determine whether the local memory address corresponds to a coherency directory cache entry of a plurality of coherency directory cache entries of a coherency directory cache; and
responsive to determining that the local memory address corresponds to a coherency directory cache entry, determine, based on a status indicator of the coherency directory cache entry corresponding to a memory granule associated with the local memory address, whether a remote snoop is required for the memory access request;
wherein retrieving the coherency directory entry of the plurality of coherency directory entries of the coherency directory corresponding to the local memory address is responsive to determining that the local memory address does not correspond to a coherency directory cache entry of the plurality of coherency directory cache entries of the coherency directory cache.

24. The non-transitory computer-readable medium of claim 23 having stored thereon computer-executable instructions which, when executed by a processor, further cause the processor to, subsequent to retrieving the coherency directory entry of the plurality of coherency directory entries of the coherency directory corresponding to the local memory address, cache the coherency directory entry in the coherency directory cache.

25. The non-transitory computer-readable medium of claim 20 having stored thereon computer-executable instructions which, when executed by a processor, further cause the processor to, prior to retrieving the coherency directory entry of the plurality of coherency directory entries of the coherency directory corresponding to the local memory address, determine whether a remote access indicator of a plurality of remote access indicators of a remote access indicator array corresponding to the local memory address is set;
wherein:
retrieving the coherency directory entry of the plurality of coherency directory entries of the coherency directory corresponding to the local memory address is responsive to determining that a remote access indicator of the plurality of remote access indicators of the remote access indicator array corresponding to the local memory address is set; and
returning data from the local memory hierarchy for the memory access request is responsive to determining that a remote access indicator of the plurality of remote access indicators of the remote access indicator array corresponding to the local memory address is not set.

26. The non-transitory computer-readable medium of claim 25 having stored thereon computer-executable instructions which, when executed by a processor, further cause the processor to, subsequent to performing the remote snoop of the one or more remote processor sockets of the plurality of processor sockets indicated by the status indicator, reset the remote access indicator of the plurality of remote access indicators of the remote access indicator array corresponding to the local memory address.

27. The non-transitory computer-readable medium of claim 25 having stored thereon computer-executable instructions which, when executed by a processor, further cause the processor to:
determine whether any status indicator of the one or more status indicators of the plurality of coherency directory entries of the coherency directory corresponding to the plural subset of memory granules represented by a remote access indicator of the plurality of remote access indicators is set; and
responsive to determining that no status indicator of the one or more status indicators corresponding to the plural subset of memory granules is set, clear the remote access indicator.
